(19) United States
(12) Patent Application Publication
(10) Pub. No.: US 2019/0142002 A1
(43) Pub. Date: May 16, 2019

(54) AN ANTIMICROBIAL COMPOSITION, PROCESS FOR PREPARING THE SAME AND METHOD OF USE THEREOF

(71) Applicant: ISP INVESTMENTS LLC, Wilming, DE (US)

(72) Inventors: Raman PREMACHANDRAN, Saddle Brook, NJ (US); Najeeb H. HAKIMI, Edison, NJ (US); Ryan V. BLAZEWICZ, Lake Hiawatha, NJ (US); Jennifer MUSYOKI, Prospect Park, NJ (US); Karen WINKOWSKI, Springfield, NJ (US)

(73) Assignee: ISP INVESTMENTS LLC, Wilmington, DE (US)

(21) Appl. No.: 16/096,422

(22) PCT Filed: Apr. 25, 2017
(86) PCT No.: PCT/US17/29435

§ 371 Date: Oct. 25, 2018

Related U.S. Application Data
(60) Provisional application No. 62/326,981, filed on Apr. 25, 2016.

(51) Int. Cl. A01N 43/36; A01N 25/10; C08F 226/06

(52) U.S. Cl. CPC A01N 43/36; C08F 226/06; A01N 25/10

(57) ABSTRACT

An antimicrobial polymer composition comprising: (i) about 0.1 wt. % to about 50 wt. % of efficacy enhancing poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₄ to C₂₀ amines; (ii) about 0.1 wt. % to about 50 wt. % of at least one neutralizing agent for enhancing efficacy of said polymer; and (iii) about 0.1 wt. % to about 99.9 wt. % of delivery system comprising at least one solvent. Also disclosed is a process for preparing the antimicrobial compositions and methods of use thereof.

### FIELD OF THE INVENTION

The present application relates to an antimicrobial composition, and, more particularly, to an antimicrobial polymer composition comprising at least one poly (isobutylene-co-maleic anhydride) polymer(s) or its functionalized derivatives, at least one neutralizing agent, and a delivery system comprising at least one solvent or system of solvent. Also disclosed is a process for preparing the compositions and method of use thereof.

### BACKGROUND OF THE INVENTION

Antimicrobial polymers can be classified as (1) Polymeric biocides, (2) biocidal polymers. The polymeric biocides consist of known biocide groups that are attached directly to the polymer backbone or to the side chain of the polymers. Depending on the functionality of these biocides groups attached, these biocidal groups could be released from the polymer and have a negative impact on the toxicity or environment. The second class, the biocidal polymers, consists of a polymer where no known biocides groups are attached to the back bone or the side chains. These molecules are typically amphiphilic and interface directly with the negatively charged microbial cell membrane disrupting its functions and causing microbial cell death. These molecules can act as a booster for conventional and progressive preservatives at low use levels. Many antimicrobial polymers are available commercially in the first category while only biguanides types are available in the second category. Biocidal polymers antimicrobial efficacy is higher for copolymers than homo polymers and its efficacy decrease with increase in molecular weight of the homo or copolymer being employed.

The biguanide based polymers available in the market have a molecular weight of 2000 and the distribution ranges from 1000 to 4000, which includes high concentration of antimicrobial active monomers. The mechanism of action includes the disruption of the microbial cell membranes by the penetration of the monomers or low molecular weight polymeric surfactant. These molecules can be toxic and are currently regulated. A better approach when designing a biocidal polymer would be to design a high molecular weight polymers (>6K) with low monomer content, that still allows the polymer to interact with the microbial cell membranes to disrupt its functions. Theoretically, the polymer could adhere to the microbial surface and the hydrophobic side chain of the polymers could rupture the membrane by physical force. Additionally, this higher molecular weight polymer could be designed to contain several positively charged groups distributed in the backbone (based on pH) for better adherence to the negatively charged microbial cytoplasmic membrane. Moreover, the polymer could be designed to have enough hydrophobic hands to exert the polymer around the microbial cell to rupture their membranes. The polymer flexibility and its conformation are critical for exerting its antimicrobial activity. Additionally, in aqueous formulations where these polymers are used to boost a known preservative molecule, these biocidal polymers should be labile and undergo less self-association or any association with anionic surfactants or anionic polymers to prevent compatibility issues. The association is typically stronger with polymers compared to surfactants with same surface charge.

United States Publication No. 20150051352 assigned to ISP Investments Inc. discloses multifunctional polymers comprising at least one anhydride repeating unit with at least one pseudo-cationic moiety graft and at least one hydrophobic graft. The grafting functionalizations can occur before, during, or after polymerizing the monomer(s). The anhydride employed may be partially or fully opened to provide amic acids, carboxylic acids, carboxylic acidic salts, imides, esters, and mixtures thereof. The polymers also may comprise other repeating units, including, but not limited to, alpha-olefins. In one embodiment, the polymers exhibit antimicrobial activity, and can be employed in a wide variety of compositions, including those where antimicrobial activity is useful. A method of providing microbial activity also is provided.

United States Publication No. US 20150044161 A1 assigned to ISP Investments Inc. discloses multifunctional polymers comprising a first repeating unit having at least one pseudo-cationic moiety, a second repeating unit having at least a hydrophobic moiety, and a third repeating unit, where the weight-average molecular weight is less than about 10,000 Da. In one embodiment, the polymers exhibit antimicrobial activity. Also provided are compositions formulated with the multifunctional polymers, and a method of providing antimicrobial activity.

EP1633192A1 assigned to Arch UK Biocides Limited discloses a method for inhibiting the growth of micro-organisms on surfaces by means of a composition comprising a non-ionic vinyl comb type co-polymer and an antimicrobial agent. The antimicrobial agent is controllably released from the vinyl co-polymer over time thereby providing effective anti-microbial control.

An article titled Cationic Antimicrobial Polymers and Their Assemblies (Ana Maria Carmona-Ribeiro, and Leticia Dias de Melo Carrasco Int. J. Mol. Sci. 1, 2013, 14, 9906-9946) discloses that cationic compounds are promising candidates for development of antimicrobial agents. Positive charges attached to surfaces, particles, polymers, peptides or bilayers have been used as antimicrobial agents by themselves or in sophisticated formulations. The main positively charged moieties in these natural or synthetic structures are quaternary ammonium groups, resulting in quaternary ammonium compounds (QACs). The advantage of amphiphilic cationic polymers when compared to small amphiphilic molecules is their enhanced microbicidal activity. Besides, many of these polymeric structures also show low toxicity to human cells; a major requirement for biomedical applications. Determination of the specific elements in polymers, which affect their antimicrobial activity has been previously difficult due to broad molecular weight distributions and random sequences characteristic of radical polymerization. With the advances in polymerization control, selection of well-defined polymers and structures are allowing greater insight into their structure-antimicrobial activity relationship. On the other hand, antimicrobial polymers grafted or self-assembled to inert or non-inert vehicles can yield hybrid antimicrobial nanostructures or films, which can act as antimicrobials by themselves or deliver bioactive molecules for a variety of applications, such as wound dressing, photodynamic antimicrobial therapy, food packing and preservation and antifouling applications.

Other non-limiting articles relevant to present application are (i) Biocidal polymers: synthesis and antimicrobial properties of benzaldehyde derivatives immobilized onto amine-terminated polyacrylonitrile, Abdullah Alamri, Mohamed H El-Newehyand Salem S Al-Deyab; Chemistry Central Journal 6, 2012, 111; (ii) The Chemistry and Applications of Antimicrobial Polymers: A State-of-the-Art Review; El-Refaie Kenawy, S. D. Worley, and Roy Broughton; Biomacromolecules, 8 (5), 2007,1359-1384 (iii) A review of polymer dissolution; Beth A. Miller-Chou, Jack L. Koenig, Frog. Polym. Sci. 28, 2003 1223-1270.

In view of the foregoing, there is a need to develop an antimicrobial polymer which can overcome existing drawbacks in the relevant field. Particularly, the present application provides an antimicrobial polymer that (i) is compatible when used in end-user products (ii) can be delivered at oil-water interface to enhance preservative efficacy (iii) effectively partitions at the oil-water interface to provide enhanced efficacy.

Other non-limiting objectives of the present application is to provide (i) potential solvents that can help provide stretched confirmation compared to coiled confirmation of antimicrobial polymer (ii) appropriate acids that help neutralize the antimicrobial polymer that can enhance its efficacy and (iii) a specific delivery system that helps to reduce the use levels of antimicrobial polymer.

### SUMMARY OF THE INVENTION

The primary objective of the present application is to provide an antimicrobial polymer composition comprising: (i) about 0.1 wt. % to about 50 wt. % of efficacy enhancing poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₄ to C₂₀ amines; (ii) about 0.1 wt. % to about 50 wt. % of at least one neutralizing agent for enhancing efficacy of said polymer; and (iii) about 0.1 wt. % to about 99.9 wt. % of a delivery system comprising at least one solvent.

Another aspect of the present application provides a process for preparing an aqueous antimicrobial composition comprising the steps of: (i) preparing a poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₁ to C₁₂ amines; (ii) neutralizing the polymer obtained in step (i) with about 0.1 wt. % to about 25 wt. % of at least one neutralizing agent for enhancing efficacy of said polymer; (iii) optionally, incorporating about 0.1 wt. % to about 25 wt. % of at least one antimicrobial agent to step (ii); and (iv) adding about 0.1 wt. % to about 80 wt. % of at least one solvent to step (iii) to obtain desired aqueous antimicrobial composition.

Yet another aspect of the present application provides a process for preparing an aqueous antimicrobial composition comprising the steps of: (i) preparing a poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₁ to C₁₂ amines; (ii) neutralizing the polymer obtained in step (i) with about 0.1 wt. % to about 25 wt. % of at least one neutralizing agent for enhancing efficacy of said polymer; (iii) with or without incorporating about 0.1 wt. % to about 25 wt. % of at least one antimicrobial agent to step (ii); and (iv) adding about 0.1 wt. % to about 80 wt. % of at least one solvent to step (iii) to obtain desired aqueous antimicrobial composition.

Still another aspect of present application is to provide a method for inhibiting or killing microbial growth comprising incorporating an effective amount of antimicrobial composition of the present invention in aqueous or non-aqueous based end-user applications or products selected from the group consisting of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and/or oral care compositions.

According to yet another aspect of the present application, the antimicrobial composition comprises functionalized poly (isobutylene-co-maleic anhydride) polymer having the structure:

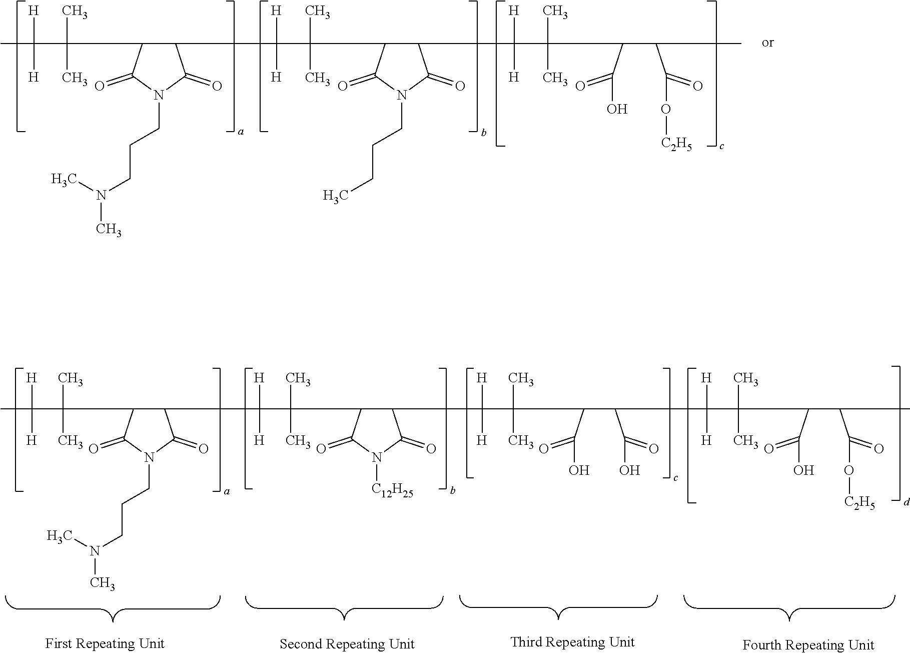

wherein each a, b, c and d has a value from about 0.1 to 100 mole percent with the proviso that the sum of said a, b, d and d is equal to 100 mole percent, wherein the polymer is alternating, block, or random.

Another aspect discloses that the compositions of the present application can be employed in the field of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and/or oral care compositions

An important aspect discloses that the compositions of the present application can be formulated as solutions, oils, lotions, creams, ointments, liquids, gels, solids, W/O emulsions, O/W emulsions, milks, suspensions, microemulsions, dispersions, microencapsulated products, sticks, balms, tonics, pastes, mists, reconstitutable products, peels, soaps, aerosols, mousses, waxes, glues, pomades, spritzes, putties, lacquers, serums, perms, powders, pencils, flakes, blush, highlighters, bronzers, concealers, baby wipes, rinse off products, or wet wipes.

### DETAILED DESCRIPTION OF THE INVENTION

While this specification concludes with claims particularly pointing out and distinctly claiming that which is regarded as the invention, it is anticipated that the invention can be more readily understood through reading the following detailed description of the invention and study of the included examples.

The singular forms “a,” “an,” and “the” include plural forms unless the context clearly dictates otherwise specified or clearly implied to the contrary by the context in which the reference is made. The term “Comprising” and “Comprises of” includes the more restrictive claims such as “Consisting essentially of” and “Consisting of”. More particularly, as used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, BXn, BXn+1, or combinations thereof” is intended to include at least one of: A, BXn, BXn+1, ABXn, A BXn+1, BXnBXn+1, or ABXnBXn+1 and, if order is important in a particular context, also BXnA, BXn+1A, BXn+1BXn, BXn+1BXnA, BXnBXn+1A, ABXn+1BXn, BXnABXn+1, or BXn+1ABXn. Continuing with this example, expressly included are combinations that contain repeats of one or more item or term, such as BXnBXn, AAA, MBXn, BXnBXnBXn+1, AAABXnBXn+1BXn+1BXn+1BXn+1, BXn+1BXnBXnAAA, BXn+1A BXnABXnBXn, and so forth. The skilled artisan will understand that typically there is no limit on the number of items or terms in any combination, unless otherwise apparent from the context.

The term “about” can indicate a difference of 10 percent of the value specified. Numerical ranges as used herein are meant to include every number and subset of numbers enclosed within that range, whether particularly disclosed or not. Further, these numerical ranges should be construed as providing support for a claim directed to any number or subset of numbers in that range.

The term “each independently selected from the group consisting of” means when a group appears more than once in a structure, that group may be selected independently each time it appears.

All percentages, parts, proportions and ratios as used herein, are by weight of the total composition, unless otherwise specified. All such weights as they pertain to listed ingredients are based on the active level and, therefore; do not include solvents or by-products that may be included in commercially available materials, unless otherwise specified.

All references to singular characteristics or limitations of the present invention shall include the corresponding plural characteristic or limitation, and vice-versa, unless otherwise specified or clearly implied to the contrary by the context in which the reference is made.

As used herein, the words “preferred” or “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

References herein to “one embodiment” or “one aspect” or “one version” or “one objective” of the invention include one or more such embodiment, aspect, version or objective, unless the context clearly dictates otherwise.

All publications, articles, papers, patents, patent publications, and other references cited herein are hereby incorporated herein in their entirety for all purposes to the extent consistent with the disclosure herein.

The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combinations of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

The term “microbe” refers to any bacterium, fungus, protozoan, and any combination thereof. The term “antimicrobial” refers to a substance that kills or inhibits the growth of microbes such as bacterium, fungus, or protozoan, or combinations thereof. Antimicrobials may kill microbes (microbiocidal) and/or prevent the growth of microbes (microbiostatic). The term “antimicrobial activity” refers to activity that kills and/or inhibits the growth of one or more microbes.

As used herein, the term “IB-MA polymer” is interchangeably used to refer poly(isobutylene-co-maleic anhydride) polymer.

The term “pseudo-cationic moiety” refers to a moiety comprising one or more functionalized and unfunctionalized nitrogen or phosphorus.

The term “polymer” refers to a compound comprising repeating structural units (monomers) connected by covalent chemical bonds. Polymers may be further derivatized, crosslinked, grafted or end-capped. Non-limiting examples of polymers include copolymers, terpolymers, quaternary polymers, and homologues. The term “copolymer” refers to a polymer consisting essentially of two or more different types of monomers polymerized to obtain said copolymer, for example, a terpolymer or tetrapolymer and the like.

The term “monomer” refers to a small molecule that chemically bonds during polymerization to one or more monomers of the same or different kind to form a polymer. The term “homopolymer” refers to a polymer that consists essentially of a single monomer type. The term “non-homopolymer” refers to a polymer that comprises more than one monomer types. The term “copolymer” refers to a non-homopolymer that comprises two different monomer types.

The term “polymerization” refers to methods for chemically reacting repeating units to form polymer chains. The type of polymerization method may be selected from a wide variety of methods. Such methods include, but are not limited to, free radical polymerization, such as classical radical polymerization and controlled radical polymerization, Nitroxide Mediation Polymerization (NMP), Atom Transfer Radical Polymerization (ATRP), and Reversible Addition Fragmentation Chain-Transfer (RAFT). The term polymerization” also refers to condensation polymerization methods

The term “hydrophilic” refers to a molecular entity that tends to be polar and water-soluble or water-miscible. A hydrophilic molecule or portion of a molecule may be charge-polarized and/or capable of hydrogen bonding enabling it to dissolve in water.

The term “hydrophobic” refers to a molecular entity that tends to be non-polar and non-water-soluble.

What is described herein is an antimicrobial polymer composition comprising: (i) about 0.1 wt. % to about 50 wt. % of efficacy enhancing poly(isobutylene-co-maleic anhydride) polymer (IB-MA polymer) functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₄ to C₂₀ amines; (ii) about 0.1 wt. % to about 50 wt. % of at least one neutralizing agent for enhancing efficacy of said polymer; and (iii) about 0.1 wt. % to about 99.9 wt. % of a delivery system comprising at least one solvent, wherein, the composition is aqueous, aqueous miscible or non-aqueous in nature

According to one important embodiment of the present application, the poly(isobutylene-co-maleic anhydride) polymer is provided with at least two, at least three or at least four repetitive units of “isobutylene-co-maleic anhydride” units, and wherein, each unit is duly functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols or (c) at least one hydrophobic moiety selected from functionalized and unfunctionalized C₁ to C₁₂ amines.

According to another important embodiment of the present application, the pseudo cationic agents are selected from the group consisting of functionalized and unfunctionalized primary, secondary or tertiary amines, and wherein, the preferred primary/secondary/tertiary amines can be primary alkyl amines, secondary alkyl amines, and/or tertiary alkyl amines A different embodiment of the present application discloses that the pseudo cationic agent is functionalized or unfunctionalized tertiary alkyl amines

Suitable nitrogen-containing amines of the present application can be primary or secondary or tertiary amines having 1 to 20 carbons, preferably 1 to 15 carbons and having the following structural formula:

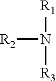

wherein R₁, R₂, R₃ each independently is hydrogen, C₁₋₂₀ alkyl, C₁₋₂₀ cycloalkyl or monocyclic aromatic hydrocarbon group such as alkyl, cycloalkyl or aryl, preferably R₁, R₂, R₃ is/are alkyl, primary, secondary, or tertiary alkyl radical containing three or more carbon atoms, such as i-propyl, t-butyl, n-hexyl and, most preferably, alkyl having 1 to 15 carbons. Wherein, the alkyl, cycloalkyl and aryl groups are those hydrocarbon groups wherein the nitrogen is bonded, respectively, to an alkyl, cycloalkyl or aryl carbon thus including such groups as aralkyl, alkylcycloalkyl, alkaryl, etc., as well as purely alkyl, cycloalkyl and aryl groups.

Another embodiment of the present application discloses that the antimicrobial composition, contains a C₁ to C₆ alcohol, and the hydrophobic moiety is C₄ to C₁₂ alkyl amines

The polymer of the present application can have a weight-average molecular weight ranging from about 1,000 Da to about 200,000 Da. Other ranges of molecular weights include, but are not limited to, from about 1,000 Da to about 50,000 Da; from about 50,000 Da to about 100,000 Da; from about 100,000 Da to about 150,000 Da; from about 150,000 Da to about 2000,000 Da. Other specific preferred weight-average molecular weight range is from about 2,000 Da to about 80,000 Da.

In a specific embodiment of the present application, it is contemplated that the antimicrobial polymer composition comprising:
(i) about 0.1 wt. % to about 50 wt. % of efficacy enhancing at least one multifunctional polymer or “IB-MA polymers” comprising at least: (A) at least a first repeating unit selected from the group consisting of:

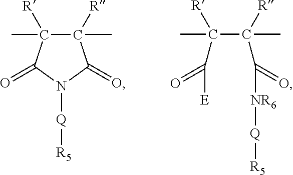

and combinations thereof, and (B) at least a second/third/fourth repeating unit is selected from the group consisting of:

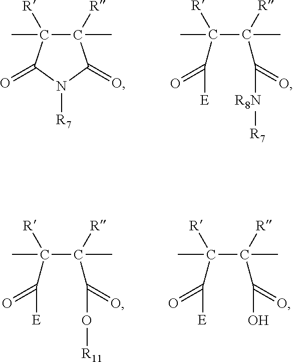

and combinations thereof, wherein
each C— indicates a bond from said unit to another unit along the polymer backbone;
each R′ and R″ is independently selected from the group consisting of: hydrogen, alkyl, cycloalkyl, aryl, and combinations thereof; each R₅ is independently selected from the group consisting of —NR₉R₁₀, functionalized and unfunctionalized nitrogen or phosphorus containing C₅-C₇ cyclic groups, and mixtures thereof; each R₆, R₈, R₉, and R₁₀ is independently selected from the group consisting of hydrogen, functionalized and unfunctionalized alkyl, alkoxy, cycloalkyl, alkenyl, cycloalkenyl, aryl groups, wherein any of the before mentioned groups may be with or without heteroatoms, and mixtures thereof; each R₇ and R₁₁ is independently selected from the group consisting of functionalized and unfunctionalized alkyl, alkoxy, cycloalkyl, alkenyl, cycloalkenyl, and aryl groups, wherein any of the before mentioned groups may be with or without heteroatoms, and mixtures thereof; each Q is independently selected from the group consisting of functionalized or unfunctionalized alkylene, cycloalkylene, and combinations thereof, wherein any of the functionalized or unfunctionalized alkylene groups may be with or without heteroatoms, and mixtures thereof; each E is independently selected from the group consisting of —OM, —OR₇, —NHR₇, —NR₇R₁₁, and mixtures thereof; and each M is independently selected from the group consisting of hydrogen, alkali metal ions, alkaline earth metal ions, ammonium ions, and mixtures thereof, and wherein, the selection of the generic substituent R′ and R″, R₅, R₆, R₇, R₈, R₉, R₁₀, R₁₁, Q, and M provides polymers that exhibit antimicrobial activity as well functionality for formulated compositions;
(ii) about 0.1 wt. % to about 50 wt. % of at least one neutralizing agent for enhancing efficacy of said polymer; and
(iii) about 0.1 wt. % to about 99.9 wt. % of delivery system comprising at least one solvent.

The term “alkyl” refers to groups such as: methyl, ethyl, n-propyl, iso-propyl, n-butyl, iso-butyl, sec-butyl, tert-butyl, n-pentyl, sec-pentyl, tert-pentyl, n-hexyl, n-heptyl, n-octyl, 2-ethylhexyl, n-nonyl, iso-nonyl, 2-propylheptyl, n-decyl, n-dodecyl, n-tridecyl, iso-tri-decyl, n-tetradecyl, n-hexydecyl, n-octadecyl and eicosyl.

The term “alkylene” refers to groups such as: methylene, ethylene, n-propylene, iso-propylene, n-butylene, iso-butylene, sec-butylene, tert-butylene, n-pentylene, sec-pentylene, tert-pentylene, n-hexylene, n-heptylene, n-octylene, 2-ethylhexylene, n-nonylene, iso-nonylene, 2-propylheptylene, n-decylene, n-dodecylene, n-tridecylene, iso-tri-decylene, n-tetradecylene, n-hexydecylene, n-octadecylene and eicosylene.

According to yet another important embodiment of the present application, the specific IB-MA polymers or multifunctional polymers employed in the present application would include but not limited to:

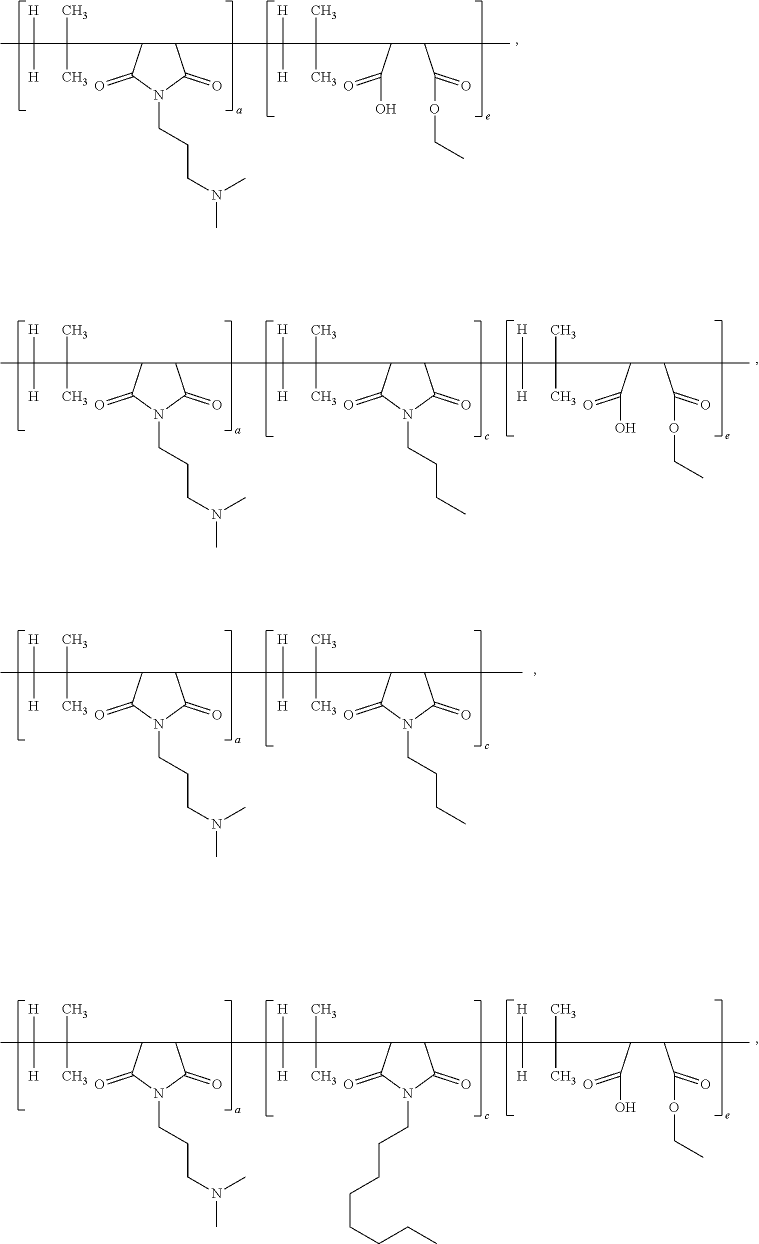

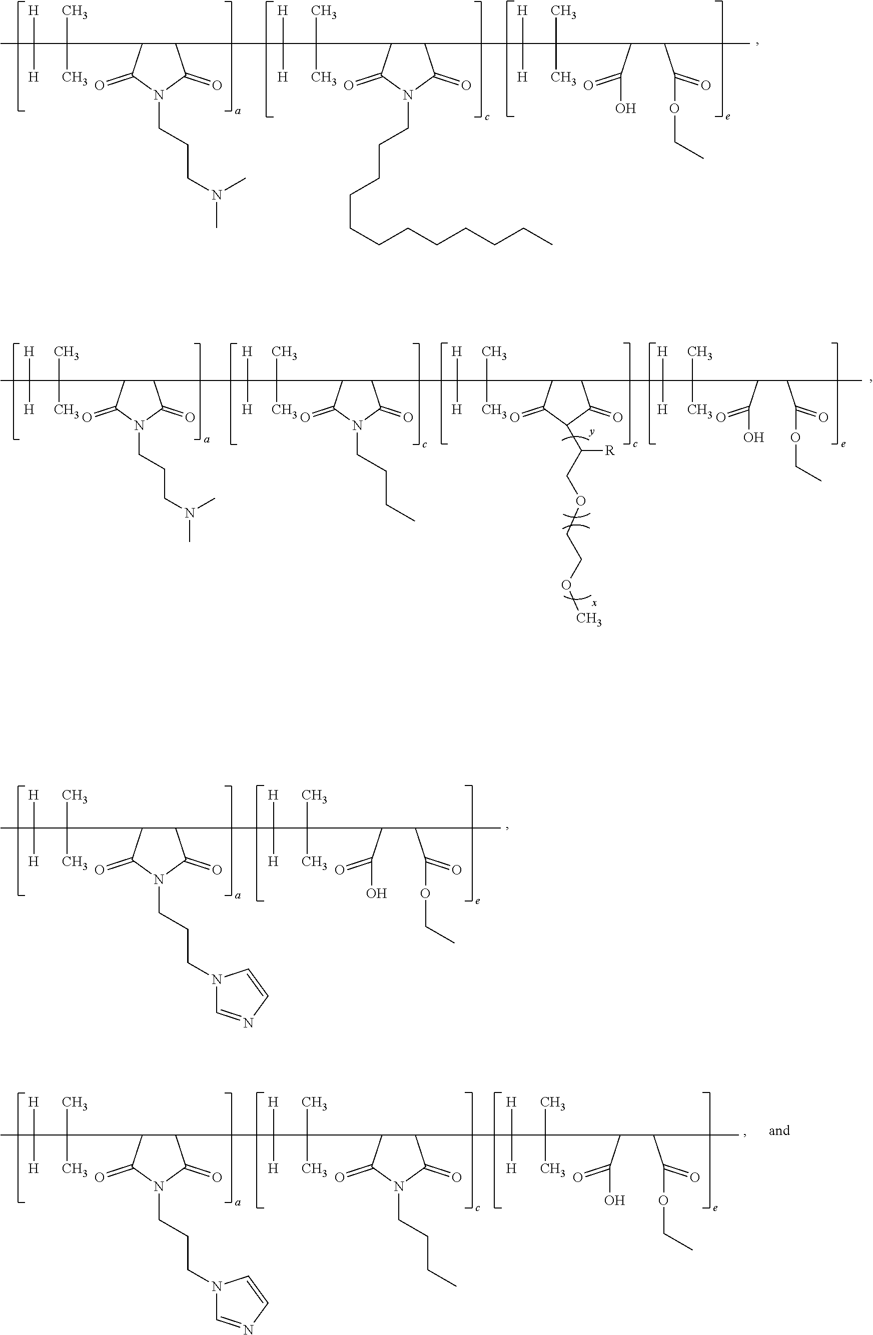

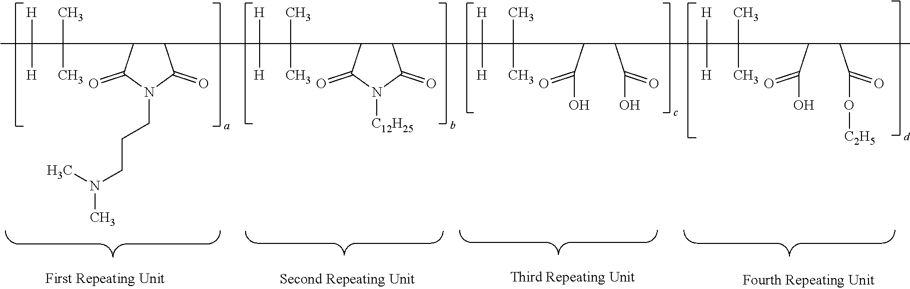

wherein the subscripts a, b, c, d, and e are molar ratios whose sum in each polymer equal 100%.

According to still another embodiment of the present application, there is provided an antimicrobial polymer composition comprising:

(i) about 0.1 wt. % to about 50 wt. % of efficacy enhancing poly (isobutylene-co-maleic anhydride) nolvmer haying the structure:

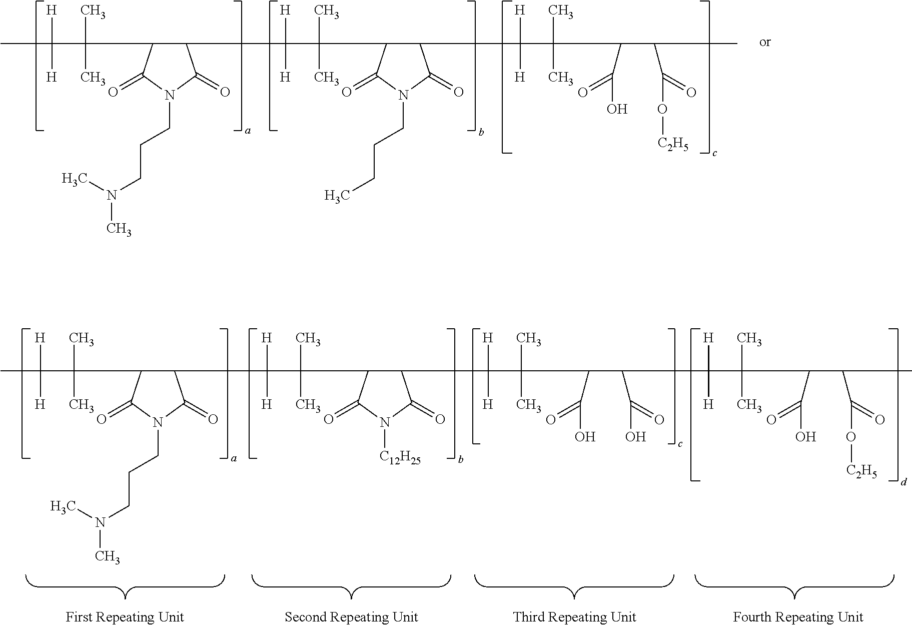

wherein each a, b, c and d has a value from about 0.1 to 100 mole percent with the proviso that the sum of said a, b, c and d is equal to 100 mole percent, wherein the polymer is alternating, block, or random; (ii) about 0.1 wt. % to about 50 wt. % of at least one neutralizing agent for enhancing efficacy of said polymer; and (iii) about 0.1 wt. % to about 99.9 wt. % of a delivery system comprising at least one solvent, wherein, the specific ratio of polymer (a:b:c:d) is 60:5:35:5.

As set out above, the maleic anhydride based polymer can be partially or fully ring-opened to provide amic acids, carboxylic acids, carboxylic acid salts, imides, esters, and mixtures thereof. The partially or fully ring-opened polymers, and mixtures thereof, can be converted to a variety of useful polymers having a wide variety of physical and mechanical properties to suit a particular application. The polymers may be random, block, or alternating polymers. The properties of the multifunctional polymers can be further designed by appropriate selection of the types of polymers employed, the ratios of the polymers and the degree and type of ring opening, and the hydrophilic/hydrophobic amino functionalities to provide the desired physical properties of the multifunctional polymers including the hydrophilic, hydrophobic, and mechanical properties.

In a specific and non-limiting embodiment of the present application, it is disclosed that the water-soluble Isobutylene/Maleic anhydride (IB-MA) polymers have demonstrated to have significant antimicrobial properties. In particular, IB-MA grafted with 60% functional amino groups (to have high surface charge) with octylamine and dodecylamine showed higher antifungal efficacy (in vitro 3-5 log kill reduction) when compared to other polymers synthesized with lower surface charge and different chain length hydrophobes. Low length hydrophobes slightly tend to favor the antibacterial activity compared to antifungal. However, when these polymers were tested as antifungal/antibacterial preservative in several personal care formulations, a significant decrease in the antifungal activity was observed. Moreover, the emulsion structure was destroyed in the presence of anionic polymers, which are widely used as thickening and suspending agents in a majority of the personal care formulations. The incompatibility and loss of antifungal efficacy could be attributed to the interaction between the positive charge groups of the biocidal polymer with negatively charged rheology modifier polymer which leads to the precipitation of the polymers due to the formation of an insoluble complex. Furthermore, the formation of this insoluble complex reduces the charge centers that can be critical for the biocidal polymer to adhere to the microbial surface. The complex formation increased when the polymers surface charge density and the strength of hydrophobic interaction where higher. The incompatibility issues with the anionic rheology modifiers were found to decrease when decreasing the charge density of the polymer for same hydrophobic group. Unfortunately, on reducing the charge density of these biocidal polymers, the water solubility was also decreased drastically affecting its efficacy even in the absence of anionic thickeners. The efficacy also depends on the swelling and solubility of the polymer in the formulations. One other criterion for preservative boosting or efficacy is to deliver all the actives at the oil water interface.

To overcome the drawbacks of the biocidal polymers, a delivery system for the biocidal polymer was designed. The delivery system enhanced the antifungal activity, as it allowed the polymer to swell, solubilize and better partition into the oil/water interface. Moreover, the delivery system prevents the biocidal polymer from self-interacting or interacting with any anionic charged polymers, thus enhancing its efficacy. The delivery system helps the diffusion of the polymer to reach the interface at fast rate. Furthermore; the delivery system is designed to control the surface charge of the biocidal polymer by neutralizing it with both organic and mineral acids at the desired level to modify the cationic surface charge and counter-ion, to minimize the interaction with anionic polymers. The biocidal polymer delivery system helps to reduce the use level of the polymer to render better efficacy.

Accordingly, the important objectives/aspects of the present application include:

(1) to provide compositions comprising multifunctional or IB-MA polymer in a water-solvent mixture to deliver the polymer at oil-water interface to significantly enhance the preservative boosting and antimicrobial efficacy, and wherein, the antimicrobial polymers used do not specifically employ a biocide group (biocidal polymer) and moreover, uses physical mechanism to rupture the membrane to work as a preservative antimicrobial/antifungal booster;

(2) to provide improved antimicrobial composition comprising antimicrobial polymer, and wherein, the improvement is made by controlling the surface charge of the polymer by neutralizing them with both appropriate weak organic acids and strong mineral acids to improve compatibility with the end-user products containing anionic surfactants and/or polymers;

(3) to provide a specific solvent-water mixture that helps to swell and solubilize the biocidal or antimicrobial polymers of the present application, and facilitate their partitioning to deliver the antimicrobial polymer at the oil-water interface at a fast rate;

(4) to provide appropriate solvent or mixture of solvents that can provide a stretched confirmation of antimicrobial polymer as compared to that of coiled confirmation and thereby enhancing the efficacy of antimicrobial polymers of the present application;

(5) to provide appropriate and specific acids which can neutralize the antimicrobial polymer and thereby enhancing their preservative efficacy through the protection of its positive charge from complexation with other anionic species present in the end-user compositions; and

(6) to provide a specific delivery system that helps in reducing the use levels of antimicrobial polymer by preventing self-interaction between the polymers and by lowering the electrostatic interaction with other charged species present in the compositions.

According to another specific embodiment of the present application, the ratio of first repeating unit, second repeating unit and third repeating unit of multifunctional or IB-MA polymer is 60:5:35. Other preferred ratio are 50:10:40; or 40:15:45; or 60:20:20. The structure of multifunctional polymer or IB-MA polymer having first/second/third repeating units is provided below:

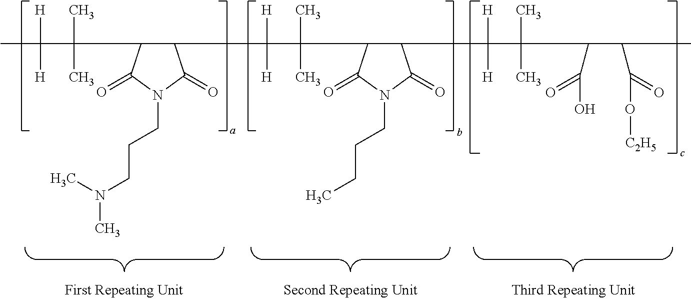

Another specific embodiment of the present application, the ratio of first repeating unit, second repeating unit, third repeating unit and fourth repeating unit of multifunctional or IB-MA polymer (a:b:c:d) is 60:5:30:5. Other preferred ratio of a:b:c:d are 50:10:30:10; or 55:10:30:5; or 60:5:25:10. The structure of multifunctional polymer or IB-MA polymer having first/second/third/fourth repeating units before neutralization is duly provided below:

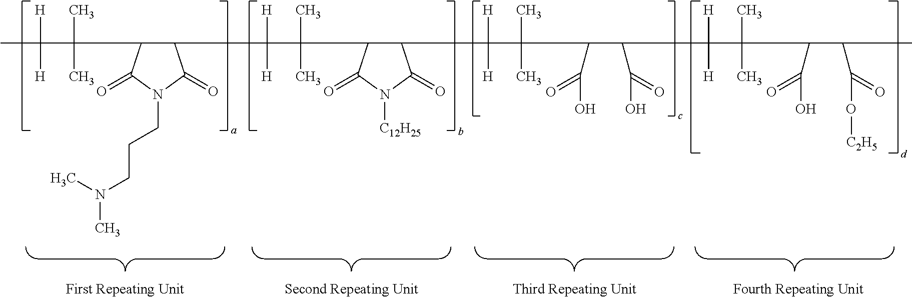

The structure of multifunctional polymer or IB-MA polymer having first/second/third/fourth repeating units after neutralization with hydrochloric acid is duly provided below:

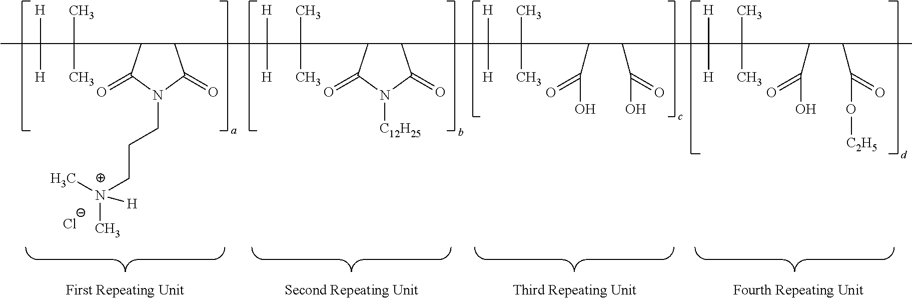

A different embodiment of the present application provides an antimicrobial polymer composition comprising: (i) about 0.1 wt. % to about 50 wt. % of efficacy enhancing poly (isobutylene-co-maleic anhydride) polymer having a structure of:

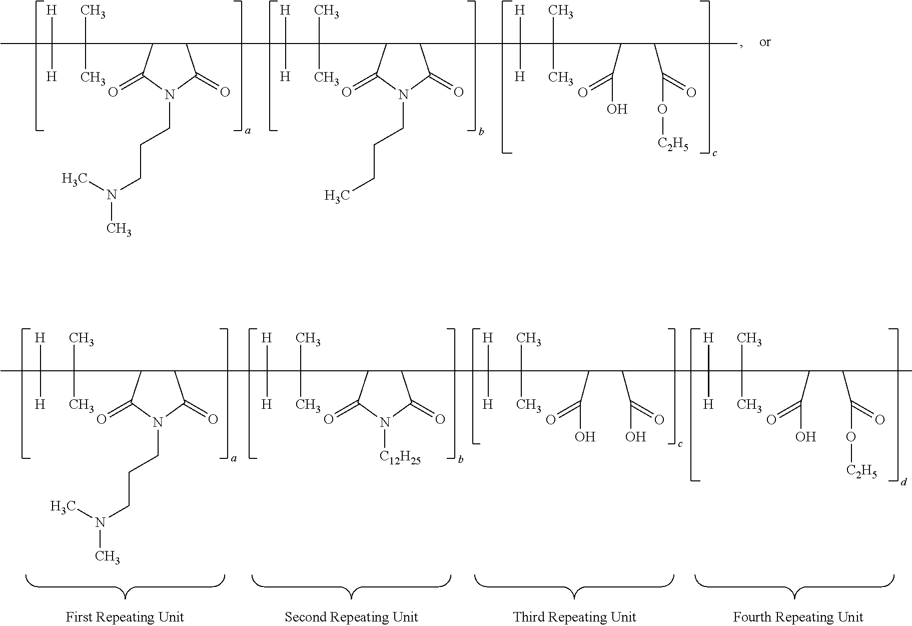

wherein each a, b, c and d has a value from about 0.1 to 100 mole percent with proviso that sum of said a, b, c and d is equal to 100 mole percent, wherein the polymer is alternating, block, or random; (ii) about 0.1 wt. % to about 50 wt. % of at least one neutralizing agent for enhancing efficacy of said polymer; and (iii) about 0.1 wt. % to about 99.9 wt. % of delivery system comprising at least one solvent. Other specific embodiments disclose that the ratio of a:b:c:d is 60:5:30:5; 50:10:30:10; 55:10:30:5; or 60:5:25:10.

According to very important embodiment of the present application, the antimicrobial polymer composition comprising: (i) about 0.1 wt. % to about 50 wt. % of efficacy enhancing poly (isobutylene-co-maleic anhydride) polymer having a structure of:

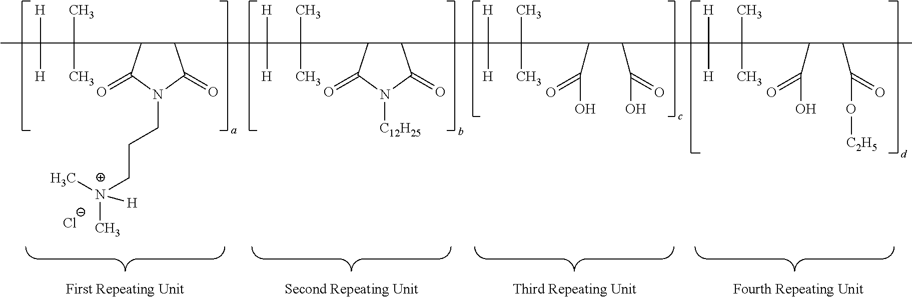

wherein each a, b, c and d has a value from about 0.1 to 100 mole percent with proviso that sum of said a, b, c and d is equal to 100 mole percent, wherein the polymer is alternating, block, or random; and (ii) about 0.1 wt. % to about 99.9 wt. % of delivery system comprising at least one solvent. In other embodiments, the specific ratio of a:b:c:d is 60:5:30:5 (Polymer 12586-12(C12)); 50:10:30:10; 55:10:30:5; or 60:5:25:10.

In a different embodiment of the present application, the antimicrobial composition of the present application additionally comprises at least one antimicrobial agent, wherein said antimicrobial agent is selected from the group consisting of, but not limited to, alkali metal salts of isothiazolinones, quaternary ammonium salts, triazine derivatives, guanidine compounds, biguanides, poly biguanides, salts of organic acids, fatty amines, diamines, triamines, salts of pyrithione, copper salts, thiocyanates, carbamates, dithiocarbamates, hydantoins, silver based compounds, copper based compounds, formaldehyde releasing compounds, formaldehyde, glutaraldehyde, propionic acid salt, octanoic acid salt, salicylic acid salt, dehydroacetic acid salt, bronopol, phenoxy ethanol, menthol, eugenol, capryl alcohol, coco amine acetate, N-dodecyl-1,3-propanediamine, bis-(3-aminopropyl)dodecylamine, chlorhexidine, alexidine, sodium hydroxymethylglycinate, dimethyloldimethylhydantoin, polyhexamethylene biguanide, diazolidinyl urea, imidazolidinyl urea, polymethoxy bicyclic oxazolidines, benzyl alcohol, hexamidine isethionate, chlorobutanol, dibromopropamidine, tetrakis (hydroxymethyl)phosphonium sulfate (THPS), 2,2-dibromo-3-nitrilopropionamide (DBNPA), tri n-butyl tetradecyl phosphonium chloride (TPC), methylene bis(thiocyanate) (MBT), alkyl dithiocarbamates, alkylene dithiocarbamates, 2-hydroxypyridine-N-oxide, N-nitroso-N-cyclohexyl-hydroxylamine, 8-hydroxy-quinoline, and combinations thereof. Suitable range of antimicrobial agent is in the range of from about 0.1 wt. % to about 25 wt. % of the total composition.

The required levels of antimicrobial agents employed in the antimicrobial composition of the present application is significantly reduced to at least 2 to 8 times as compared to that of regulatory compliable or conventionally accepted use levels in the absence of antimicrobial composition.

In a specific embodiment of the present application, it is contemplated that the neutralizing agent is capable of controlling cationic surface charge and counter-ions present in poly (isobutylene-co-maleic anhydride) polymer for its efficacy enhancement, and wherein, the selection of acid and its concentration can be varied to provide complete or partial neutralization in order to enable variable positive charge and to balance the hydrophilic/hydrophobic nature of the polymer in end-use products or applications. Accordingly, the suitable neutralizing for preparing antimicrobial composition of the present application is selected from the group consisting of, but not limited to, weak organic acids, mineral acids, α-hydroxy acids, β-hydroxy acids, benzoic acid, glycolic acid, dehydroacetic acid, citric acid, anisic acid, salicylic acid, sorbic acid, lauric acid, octanoic acid, hydrochloric acid, pyruvic acid, oxalic acid, ascorbic acid, formic acid, oxalic acid, lactic acid, acetic acid, succinic acid, propionic acid, butyric acid, tartaric acid, malic acid, gluconic acid, fumaric acid, and combinations thereof.

According to another embodiment of the present application, a specific delivery system is employed to deliver the antimicrobial composition comprising (i) functionalized IB-MA polymer and (ii) at least one neutralizing agent, and wherein, the delivery system comprises at least one solvent or mixture of solvent to deliver the desired composition. Accordingly, the suitable solvent(s) employed include, but are not limited to, water, glycols, ethers of glycols, esters of glycols, polyglycols, glycerols, ether or esters of glycerols, diglycerols, triglycerol, tetraglycerol, pentaglycerol, hexaglycerol, cyclic diols, linear or non-cyclic diols, polyglycerols or their derivatives, alkylalkyl glycerins, alkylaryl glycerins, cycloalkyl glycerins, fatty acid ester of C₁ to C₂₄ alcohols, phospholipids, 1,2 alkandiols, 1,3 alkanediols, glycerin chain fatty acid esters, hydroxyorganic acids, aliphatic or aromatic alcohols having carbon chain length of C₁-C₂₀, and in combinations thereof. In a specific embodiment, it is disclosed that water/distilled water/deionized water can also be employed as suitable solvent for delivering antimicrobial polymer of the present application. Also, it is specifically disclosed that the delivery system can comprise mixture of solvents including water and other organic solvents as described here.

In another embodiment of the present application, it is contemplated to employ one or more solvents selected from the group comprising of water, glycols, ethers of glycol, esters of glycol, ethylene glycol, propylene glycol, butylene glycol, dipropylene glycol, diethylene glycol, capryl glycol, polyglycol, glycerol, ether or esters of glycerol, diglycerol, triglycerol, tetraglycerol, pentaglycerol, hexaglycerol, cyclic diols, linear or non-cyclic diols, polyglycerols or their derivatives, aliphatic or aromatic alcohols, alkoxyalkanols or aryloxyalkanols having carbon chain length of C₁-C₂₀, and in combinations thereof. The preferred glycols are ethylene glycol, 1,2-propylene glycol, 1,3-propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 3-methyl-1,5-pentanediol, 2,3-dimethyl-2,3-butanediol, 2,4-dimethyl-2-ethyl-hexane-1,3-diol, 2,2-dimethyl-1,3-propanediol, 2-ethyl-2-butyl-1,3-propanediol, 2-ethyl-2-isobutyl-1,3-propanediol, 1,2-butanediol, 1,3-butanediol, 1,4-butanediol, 1,4-pentanediol, 1,5-pentanediol, 1,6-hexanediol, 1,2-octane-diol(caprylyl glycol), 2,2,4-tetra methyl-1,6-hexanediol,thiodiethanol, 1,2-cyclohexanedimethan-ol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol and/or hydrogenated bisphenol-A. Examples of aryloxyalkanols used according to this application are phenoxyethanol and phenoxypropanols. Preferred phenoxypropanols are 1-phenoxy-2-propanol, 2-phenoxy-l-propanol or mixtures thereof, and 3-phenoxy-l-propanol. Examples of arylalkanols are 3-phenyl-1-propanol, phenethyl alcohol, veratryl alcohol (3,4-dimethoxyphenylmethyl alcohol), benzyl alcohol and 2-methyl-1-phenyl-2-propanol. The oligoalkanol aryl ethers include, for example, phenoxy-di-, -tri- and -oligoethanol and phenoxydi-, -tri- and -oligopropanol. Examples of such useful glycol ethers include propylene glycol methyl ether, dipropylene glycol methyl ether, tripropylene glycol methyl ether, propylene glycol n-propyl ether, diethylene glycol methyl ether, ethylene glycol butyl ether, diethylene glycol methyl ether, water, distilled water, deionized water, and mixtures thereof.

The antimicrobial composition of the present application is capable of inhibiting or killing Staphylococcus aureus, Staphylococcus epidermidis, Streptococcus pneumoniae, Streptococcus pyogenes, Enterococcus faecalis, Haemophilus influenzae, Moraxella species, Salmonella species, Campylobacter species, Pseudomonus aeruginosa, Clostridium botulinum, Clostridium perfringens, Corynebacteria species, Diplococci species, Mycobacteria species, Streptomyces species, Escherichia coli, Salmonella typhimurium, Salmonella enteritidis, Vibrio parahaemolyticus, Bacillus anthracia, Bacillus azotoformans, Bacillus cereus, Bacillus coagulans, Bacillus israelensis, Bacillus larvae, Bacillus mycoides, Bacillus polymyxa, Bacillus pumilis, Bacillus stearothormophillus, Bacillus subtilis, Bacillus thuringiensis, Bacillus validus, Bacillus weihenstephanensis, Bacillus pseudomycoides, Burkholderia cepacia, Burkholderia multivorans, Burkholderia cenocepacia, Burkholderia vietnamiensis, Burkholderia stabilis, Burkholderia ambifaria, Burkholderia dolosa, Burkholderia anthina, Burkholderia pyrrocinia, Candida tropicalis, Candida albicans, Hansenula anomala, Saccharomyces cerevisiae, Torulaspora delbreuckii, Zygosaccharomyces bailii, Zygosaccharomyces rouxii, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, and/or Mucor racemosus.

According to one important embodiment of the present application, it is disclosed that the antifungal/antibacterial activity can be increased by controlling the hydrophobic/hydrophilic ratio of the multi-functional/IB-MA polymer, mobility of the polymer arm, adsorption/assembly of polymer leading to condensation of the product and forcing the breakage of membrane by modifying the lipid content of the bugs, and thereby increases the antifungal efficacy with increase in chain length of the hydrophobic group, accordingly, the hydrophobic chain length is optimized around dodecyl group (C₁₂) to have right level of solubility in water. Further, the increase in chain length beyond C₁₂ leads to less solubility in water, therefore, by engaging appropriate solvents enables or allows use of hydrophobic part having more than C₁₂ chain length to have increased antifungal activity. Accordingly, the efficacy of antifungal/antibacterial activity is a matter of balance factor among the following non-limiting properties including mobility, hdyrophilic/hydrophobic nature of polymer, assembly through hydrophobic and hydrophile forces and condensation of the polymer, transport to the interface, adhesion on the surface of bugs, surface area, charge density of polymer, ability of the polymer hands to wind around the cell to physically increase the osmotic pressure, prevent the transport of essential components for the cell to multiply and grow fast, and/or solubility parameters.

According to yet another important embodiment of the present application, it is contemplated that the microemulsion based delivery system can be one of the best and appropriate system to deliver the IB-MA polymer at the interface as it can be tuned to the delivery need. The microemulsions are isotropic, thermodynamically stable transparent (or translucent) systems of oil, water and surfactants and polymers, frequently in combination with a co-surfactant with droplet size ranging from 20-200 nm. They can be classified as oil-in-water (o/w), water-in-oil (w/o) or bi-continuous systems depending on their structure and are characterized by ultra-low interfacial tension between oil and water phases. These versatile systems are currently of great technological and scientific interest to the researchers because of their potential to incorporate a wide range of hydrophilic and hydrophobic actives due to the presence of both lipophilic and hydrophilic domains. These delivery systems provide protection against oxidation, hydrolysis and improve the solubilization of lipophilic actives and hence enhance their bioavailability. Additionally, these microemulsions have advantages over colloidal systems and conventional emulsions, suspensions and micellar solutions and can target the actives to the interface for better efficacy. Also, microemulsions that have inverse micellar structure can be less comedogenic than either creams or solutions. A flexible surfactant film will enable the existence of several different structures like droplet like shapes, aggregates and bi-continuous and lamellar structures depending on the ratio of the components. The internal structure of a microemulsion vehicle is very important for the diffusivity of the phases, and thereby also for the diffusion of actives in the respective phases.

For good delivery of antimicrobial polymers of the present application, knowledge of polymer dissolution behavior can be vital. An ideal delivery system is one which targets the polymer to the microbe/water interface, so that desired efficacy is obtained at minimum use level. When the polymer is introduced to a good solvent based microemulsion for the polymer, swelling occurs allowing increased mobility of the solute, and partition the polymer into the interface with a stretched confirmation.

The most significant problem with using organic solvents with viable cells lies not with the system or reactors employed, but rather in the choice of solvents. As is well known a great number of solvents are highly cytotoxic or inhibitory. These solvents should be selected carefully to have a defined assembly structure and in addition provides antifungal/antibacterial boost to the polymer due to the inhibitory characteristic, mobility, partition and as a good solvent. The solvents and co-solvents and surfactants used to prepare microemulsion should have synergistic effect towards better water solubility/partition and mobility of the polymer. The solvents ability to permeabilize and partition substance dissolved in them as well as enhances the delivery of antimicrobial polymer. These solvents are selected to have added benefits to skin like moisturizing, soothing and mildness and tackiness.

In a specific embodiment of the present application, it is disclosed that the antimicrobial composition of the present application can be employed in the field of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and/or oral care compositions. The personal care compositions include sun care compositions, after-sun compositions, hair care compositions, conditioning compositions, skin care compositions, oral care compositions, face care compositions, lip care compositions, body care compositions, nail care compositions, anti-aging compositions, deodorant compositions, color cosmetic compositions, color-protection compositions, self-tanning compositions, and foot care compositions.

A different embodiment of the present application discloses that the antimicrobial compositions of the present application can be formulated as solutions, oils, lotions, creams, ointments, liquids, gels, solids, W/O emulsions, O/W emulsions, milks, suspensions, microemulsions, dispersions, microencapsulated products, sticks, balms, tonics, pastes, mists, reconstitutable products, peels, soaps, aerosols, mousses, waxes, glues, pomades, spritzes, putties, lacquers, serums, perms, powders, pencils, flakes, blush, highlighters, bronzers, concealers, baby wipes, rinse off products, or wet wipes.

According to a very important embodiment of the present application, the specific designed or optimized delivery system is capable of providing enhanced efficacy by bringing the antimicrobial IB-MA polymer(s) to the oil/water interface when incorporated into an aqueous or non-aqueous based end-user applications selected from the group consisting of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and/or oral care compositions. Further, the antimicrobial polymer of the present application is capable of demonstrating multi-functional properties including emulsifying property, moisturizing property, wetting or surface active property, lubricating property, and/or causing less irritation to the substrate when incorporated into the end user application.

In accordance with another embodiment of the present application, the amount of preservatives employed in end user application includes, but is not limited to, about 0.01 wt. % to about 5 wt. %, about 5 wt. % to about 10 wt. %. Other suitable ranges of preservatives would include about 0.01 to 1 wt. %, about 1 wt. % to about 2 wt. %, about 2 wt. % to about 3 wt. %, about 3 wt. % to about 4 wt. %, about 4 wt. % to about 5 wt. %, about 5 wt. % to about 6 wt. %, about 6 wt. % to about 7 wt. %, about 7 wt. % to about 8 wt. %, about 8 wt. % to about 9 wt. %, about 9 wt. % to about 10 wt. % of total composition of end user formulation.

Another important embodiment of the present application discloses a process for preparing an aqueous antimicrobial composition comprising the steps of: (i) preparing a poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₁ to C₁₂ amines; (ii) neutralizing the polymer obtained in step (i) with about 0.1 wt. % to about 25 wt. % of at least one neutralizing agent for enhancing efficacy of said polymer; (iii) optionally, incorporating about 0.1 wt. % to about 25 wt. % of at least one antimicrobial agent to step (ii); and (iv) adding about 0.1 wt. % to about 80 wt. % of at least one solvent to step (iii) to obtain desired aqueous antimicrobial composition.

Still another important embodiment of the present application discloses a process for preparing an aqueous antimicrobial composition comprising the steps of: (i) preparing a poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₁ to C₁₂ amines; (ii) neutralizing the polymer obtained in step (i) with about 0.1 wt. % to about 25 wt. % of at least one neutralizing agent for enhancing efficacy of said polymer; (iii) incorporating about 0.1 wt. % to about 25 wt. % of at least one antimicrobial agent to step (ii); and (iv) adding about 0.1 wt. % to about 80 wt. % of at least one solvent to step (iii) to obtain desired aqueous antimicrobial composition.

Another important embodiment of the present application discloses a method for inhibiting or killing microbial growth comprising incorporating an effective amount of antimicrobial composition of this invention in an aqueous or non-aqueous based end-user applications or products selected from the group consisting of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and/or oral care compositions, and wherein said end-user/consumer products having a pH in the range from about 4 to about 8.

Further, certain aspects of the present invention are illustrated in detail by way of the following examples. The examples are given herein for illustration of the invention and are not intended to be limiting thereof.

### EXAMPLES

### Example 1: Solvent Blend

| No. | Ingredients | Wt. % |
|---|---|---|
| 1 | Water | 15-25 |
| 2 | Propylene Carbonate | 10-20 |
| 3 | 1,3 Propanediol | 10-20 |
| 4 | Hexyl Glycerin | 15-25 |
| 5 | Propylene Glycol | 15-25 |
| | Monoheptanoate | |
| 6 | 1,2 Decanediol | 5-15 |
| | Total | 100.00 |

### Example 2: Composition Comprising Polymer-Solvent Blend and Benzoic Acid

| No. | Ingredients | Wt. % |
|---|---|---|
| 1 | Blend 8 | 45-55 |
| 2 | Polymer 12586-12 (C₁₂) | 35-45 |
| 3 | Benzoic Acid | 10-15 |
| | Total | 100.00 |

### Example 3: Blend 8-MCM (Solvent Delivery System)

| No. | Ingredients | Wt. % |
|---|---|---|
| 1 | Water | 15-25 |
| 2 | Propylene Carbonate | 10-20 |
| 3 | 1,3 Propanediol | 10-20 |
| 4 | Hexyl Glycerin | 15-25 |
| 5 | Glyceryl caprylate/caprate | 15-25 |
| 6 | 1,2 Decanediol | 5-15 |
| | Total | 100.00 |

### Example 4: Polymer-Slvent Blend with Benzoic Acid

| No. | Ingredients | Wt. % |
|---|---|---|
| 1 | Blend 8-MCM | 45-55 |
| 2 | Polymer 12586-12 (C₁₂) | 35-45 |
| 3 | Benzoic Acid | 10-15 |
| | Total | 100.00 |

### Example 5: Composition Comprising Solvent Blend 8-MCM-NF

| No. | Ingredients | Wt. % |
|---|---|---|
| 1 | Water | 15-25 |
| 2 | Propylene Carbonate | 10-15 |
| 3 | 1,3 Propanediol | 10-15 |
| 4 | Hexyl Glycerin | 15-20 |
| 5 | Glyceryl caprylate/caprate | 15-20 |
| 6 | 1,2 Decanediol | 5-10 |
| 7 | PEG-20 Stearate | 5-10 |
| 8 | PEG-7 Glyceryl Cocoate | 5-10 |
| | Total | 100.00 |

### Example 6: Composition Comprising Polymer-Solvent Blend

| No. | Ingredients | Wt. % |
|---|---|---|
| 1 | Blend 8-MCM-NF | 50-65 |
| 2 | Polymer 12586-12 (C12) | 25-35 |
| 3 | Benzoic Acid | 8-15 |
| | Total | 100.00 |

### Examples 7 and 8: Reverse Dilution in Delivery System

| Ingredients | Wt. % |
|---|---|
| Polymer C₁₂ (40% HCl neutralized in water) | 45-55 |
| PEG-7 Glyceryl Cocoate | 20-30 |
| Propylene Carbonate | 20-30 |
| Polymer C₁₂ (40% HCl neutralized in water) | 45-55 |
| PEG-20 Stearate | 20-30 |
| Propylene Carbonate | 20-30 |

### Example 9: Delivery Systems Comprising Different Acids and Polymer

| Ingredients (Example 9a) | Wt. % |
|---|---|
| Polymer C₁₂ (~100% un-neutralized | 35-45 |
| Blend | 45-55 |
| Benzoic Acid | 5-15 |
| Ingredients (Example 9b) | Wt. % |
| Polymer C₁₂ (~100% un-neutralized | 35-45 |
| Blend | 45-55 |
| p-Anisic Acid | 5-15 |
| Ingredients (Example 9c) | Wt. % |
| Polymer C₁₂ (~100% un-neutralized | 35-45 |
| Blend | 45-55 |
| Pyruvic Acid | 5-15 |
| Ingredients (Example 9d) | Wt. % |
| Polymer C₁₂ (~100% un-neutralized | 35-45 |
| Blend | 45-55 |
| Oxalic Acid | 5-15 |
| Ingredients (Example 9e) | Wt. % |
| Polymer C₁₂ (~100% un-neutralized | 35-45 |
| Blend | 45-55 |
| Salicylic Acid | 5-15 |
| Ingredients (Example 9f) | Wt. % |
| Polymer C₁₂ (~100% un-neutralized | 35-45 |
| Blend | 45-55 |
| Sorbic Acid | 5-15 |
| Ingredients (Example 9g) | Wt. % |
| Polymer C₁₂ (~100% un-neutralized | 35-45 |
| Blend | 45-55 |
| Lauric Acid | 5-15 |
| Ingredients (Example 9h) | Wt. % |
| Polymer C₁₂ (~100% un-neutralized | 35-45 |
| Blend | 45-55 |
| Octanoic Acid | 5-15 |
| Ingredients (Example 9i) | Wt. % |
| Polymer C₁₂ (~100% un-neutralized | 35-45 |
| Blend | 45-55 |
| HCL Acid (0.1M) | 5-15 |

### Example 10: Delivery System Comprising Differentiating Acidic Strengths and Polymer

| | |
|---|---|
| Ingredients | Wt. % |

Example 10 (a)

| | |
|---|---|
| Polymer C₁₂ (~100% un-neutralized | 35-45 |
| Blend | 45-55 |
| HCL Acid (0.1M) | 10 |

Example 10 (b)

| | |
|---|---|
| Polymer C₁₂ (~100% un-neutralized | 35-45 |
| Blend | 45-55 |
| HCL Acid (0.05M) | 10 |

### Example 11: Efficacy of Polymer in Delivery System Vs. Delivery System Alone in a Baby Wipes Formulation, pH 6

The efficacy of the polymer was tested in a baby wipes formulation (shown below), by conducting a 28-day double inoculation challenge tests (Table 1).

TABLE 1
Polymer tested in a baby wipes formulation

| INCI NAME | Ingredients | % w/w |
|---|---|---|
| Phase A | DI Water | 97.9 |
| | Citric Acid 10% aq. | 0.5 |
| Phase B | Tween 20 (Liposorb 20) | 0.2 |
| | Vitamin E (Vital ET) | 0.05 |
| | Fragrance (Petal Avalanch) | 0.05 |
| Phase C | Si Tec DMC 6031 | 0.1 |
| | Glycerin | 0.5 |
| Phase D | NaOH 10% aq. (adjust pH) | 0.2 |

| | |
|---|---|
| Total | 100 |

The efficacy of 1% solution of the polymer in the delivery system described in example 4 was compared to that of the efficacy of the delivery system described in example 3 and a control (no polymer or delivery system added). Briefly, the samples were inoculated with either Gram positive bacteria (Staphylococcus aureus 6538), a composite of Gram negative bacteria (Bac comp) Escherichia coli 8739, Pseudomonas aeruginosa 9027 and Burkholderia cepacia 25416), or a mold composite (Mold comp) (Candida albicans 10231, and Aspergillus brasiliensis 16404). The bacteria was inoculated at day 0 and day 21 to a final concentration of about 10̂6-7 cfu/ml and the fungal composite was inoculated at day 0 and day 21 to a final concentration of about 10̂5-6 spores/ml. The inoculated samples are plated at days 2, 7, 14, 21 and 28. The recovery media was Letheen Agar for bacteria and Potato Dextrose agar for fungi. The microorganisms recovered at each time interval are shown in the table below (Table 2). The polymer in the delivery solution was most effective in inhibiting all microbial growth within 14 days after inoculation as well as after the second inoculation

TABLE 2
Evaluation of efficacy of polymer

| Treatment | Microorganisms | 2 days | 7 days | 14 days | 21 days | 28 days |
|---|---|---|---|---|---|---|
| CONTROL | S. aureus | 2.24E\hat{ }6 | 1.3E\hat{ }5 | 4E\hat{ }3 | 4E\hat{ }1 | 7.36E\hat{ }6 |
| | Bac comp | 2E\hat{ }6 | 4.12E\hat{ }6 | 4.24E\hat{ }6 | 4.97E\hat{ }6 | 3.98E\hat{ }6 |
| | Mold comp | 5E\hat{ }4 | 5E\hat{ }4 | 1E\hat{ }4 | 5E\hat{ }4 | 7E\hat{ }4 |
| 1.0% Polymer C12, 60% | S. aureus | <10 | <10 | <10 | <10 | <10 |
| charge, in Delivery System | Bac comp | <10 | <10 | <10 | <10 | <10 |
| 3 (example 4) | Mold comp | 2E\hat{ }3 | 2E\hat{ }1 | <10 | <10 | <10 |
| Delivery System in | S. aureus | 2E\hat{ }2 | <10 | <10 | <10 | <10 |
| example 3 | Bac comp | 3.2E\hat{ }4 | 3.5E\hat{ }6 | 3.96E\hat{ }6 | 3.97E\hat{ }6 | 3E\hat{ }3 |
| | Mold comp | 2.2E\hat{ }4 | 4E\hat{ }4 | 1E\hat{ }3 | 2E\hat{ }2 | <10 |

### Example 12: Wipes Test with Non-Woven Wipes

The efficacy of the polymer in the delivery system described in example 4 was also tested vs. a commercial preservative in the baby wipes juice containing wipes (non-woven cellulosic wipes).

Briefly, this is a 21day single inoculation procedure that consist of a pool of microorganisms containing: Staphylococcus aureus ATCC# 6538, Escherichia coli ATCC# 8739, Pseudomonas aeruginosa ATCC# 9027, Burkholderia cepacia ATCC# 25416 (Bac comp), or Candida albicans ATCC# 10231 and Aspergillus brasiliensis ATCC# 16404 (Mold comp). The non-woven/wipes are placed in a stomacher bag and the antimicrobial wipe juice containing the antimicrobial polymer or preservative is incorporated. The wipes' system is mixed in a stomacher for 30 seconds to evenly distribute the preservatives. The wipes are placed in the dark at room temperature and left for 2-3 days to equilibrate. Inoculations are performed at test initiation (after equilibration) and recovery assays are executed at 7, 14, and 21 days. For this test method, the recovery broth used is AOAC Letheen broth. The agar media used for bacterial recovery was Tryptic Soy Agar and the media used for fungi recovery was Rose Bengal Agar with Chloramphenicol (RBAC). Routine incubation times and temperatures appropriate to the test organisms were followed. As shown in Table 3 the polymer in the delivery system as described in example 4 was effective against the bacterial composite and mold when tested at 2%.

TABLE 3
Evaluation of Polymer in delivery system Vs. Commercial Preservative

| Product | Starting | | | final | | final | | final |
|---|---|---|---|---|---|---|---|---|
| Description | pH | Microorganisms | 7 Days | pH | 14 Days | pH | 21 Days | pH |
| Control Base I | 5.95 | Bac comp | 5.60E\hat{ }5 | 4.86 | 2.80E\hat{ }4 | 4.48 | 2.90E\hat{ }5 | 4.75 |
| | | Mold comp | 3.50E\hat{ }5 | | 3.48E\hat{ }6 | | 7.00E\hat{ }6 | |
| 1.1% Commercial | 5.99 | Bac comp | <10 | 4.82 | <10 | 4.6 | <10 | 4.74 |
| Preservative* | | Mold comp | <10 | | <10 | | <10 | |
| 1.5% C12, 60% | 5.97 | Bac comp | <10 | 5.43 | <10 | 5.2 | <10 | 5.45 |
| Charge in delivery | | Mold comp | 7.00E\hat{ }1 | | 9.00E\hat{ }2 | | 8.00E\hat{ }2 | |
| System3 (Example 4) | | | | | | | | |
| 2% C12, 60% Charge | 5.98 | Bac comp | <10 | 5.47 | <10 | 5.27 | <10 | 7.64 |
| in delivery System 3 | | Mold comp | <10 | | <10 | | <10 | |
| (Example 4) | | | | | | | | |

Cellulose Non-Woven Wipes (P&G India) Base 2 (application Team);
*Phenoxyethanol (and) Caprylyl Glycol

### Example 13: Antimicrobial Boosting Effect in Baby Wipes System in Combination with Commercial Preservative

Same efficacy test was conducted as described in Example 12, except that the antimicrobial polymer in the delivery system was combined with the commercial preservative (Phenoxyethanol (and) Caprylyl Glycol). The combination of the preservative with the antimicrobial polymer as described in Example 4 offered good antimicrobial protection at low levels (0.5% antimicrobial polymer as described in example 4+0.5% Phenoxyethanol (and) Caprylyl Glycol (Table 4).

TABLE 4
Evaluation of Baby Wipes System in Combination with boosters

| Product | Starting | Micro | | final | 14 | final | 21 | final |
|---|---|---|---|---|---|---|---|---|
| Description | pH | organisms | 7 Days | pH | Days | pH | Days | pH |
| Control | 5.5 | Bac comp | >1.0E\hat{ }6 | 5.49 | >1.0E\hat{ }6 | 5.42 | >1.0E\hat{ }6 | 5.53 |
| | | Mold comp | 9.00E\hat{ }3 | | 4.9E\hat{ }3 | | 2.6E\hat{ }2 | |
| Commercial | 5.48 | Bac comp | 9.0E\hat{ }2 | 5.19 | <10 | 5.2 | <10 | 5.13 |
| Preservative 0.5% + 0.5% | | Mold comp | 7.0E\hat{ }2 | | 7.0E\hat{ }1 | | <10 | |
| C12, 60% Charge in | | | | | | | | |
| delivery System 3 | | | | | | | | |
| (Example 4) | | | | | | | | |
| 0.5% Commercial | 5.54 | Bac comp | <10 | 5.43 | <10 | 5.38 | <10 | 5.36 |
| Preservative* | | Mold comp | 3.00E\hat{ }2 | | 6.20E\hat{ }3 | | 1.20E\hat{ }3 | |

*Phenoxyethanol (and) Caprylyl Glycol.

### Example 14: Antimicrobial Boosting Effect of the Polymer when Combined with Commercial Biocides in a Commercial Liquid Detergent

The challenge tests are based on AOAC Official Method 998.10 entitled “Efficacy of Preservation of non-eye area Water-miscible Cosmetic and Toiletry Formulations” with some modifications. Briefly, this method is a 28-day procedure. Testing was performed against the mold Aspergillus brasiliensis ATCC# 16404 (the system did not support the growth of bacteria). Inoculations were performed at test initiation (day 0) and re-inoculations performed at 2, 4, 7 and 21 days. Recovery assays were executed at 2, 4, 7, 9, 14, 21 and 28 days. The recovery media for fungi used was Potato Dextrose Agar (PDA). Routine incubation times and temperatures appropriate for fungi were followed. As shown in the table below, both the unpreserved control as well as a sample treated with low levels of the antimicrobial actives BIT and MIT supported mold growth. The addition of the polymer in as described in example 9 at 0.5%, reduced the mold counts by day 14 to <10, boosting the efficacy of the commercial biocides (Table 5).

TABLE 5
Evaluation of Liquid detergent (commercial) in comparison with commercial sample

| Product | Micro | | | | | | | |
|---|---|---|---|---|---|---|---|---|
| Description | organisms | 2 Days | 4 Days | 7 Days | 9 days | 14 Days | 21 Days | 28 Days |
| Unpreserved control | Mold | 6.00E+04 | 9.00E+04 | 5.00E+04 | 7.00E+04 | 8.00E+04 | 5.00E+03 | 4.50E+04 |
| 12.5 ppm BIT & 25 ppm | Mold | 4.00E+04 | 8.00E+04 | 2.60E+04 | 1.50E+05 | 8.00E+04 | 1.00E+04 | 3.50E+05 |
| MIT | | | | | | | | |
| 12.5 ppm BIT, 25 ppm MIT | Mold | 3.00E+04 | 3.00E+04 | 4.00E+04 | 5.00E+02 | <10 | <10 | <10 |
| & 0.5% Polymer (C12)- | | | | | | | | |
| 60% charge (HCL | | | | | | | | |
| Neutralized) (Example 9) | | | | | | | | |

pH of the formulation: 8.16;
Methylisothiazolinone (MIT),
Benzisothiazolinone (BIT)

### Example 15: Antimicrobial Boosting Effect of the Polymer when Combined with a Commercial Preservative in a Sulfate Free Body Wash

The efficacy of the polymer was evaluated as described in Example 11. The combination of the antimicrobial polymer with the commercial preservative “Benzyl Alcohol (and) Benzoic Acid (and) Glycerin (and) Sorbic Acid” boost the efficacy of the preservative (Table 6).

TABLE 6
Evaluation of efficacy of polymer

| | Starting | Micro | | | | | Day | |
|---|---|---|---|---|---|---|---|---|
| Product Description | pH | organisms | Day 2 | Day 7 | Day 14 | Day 21 | 28 | Day 35 |
| Unpreserved Control | 5.83 | Bac comp | >10E\hat{ }6 | 3.1E\hat{ }6 | 1.9E\hat{ }6 | 5.4E\hat{ }5 | 1.5E\hat{ }6 | N/A |
| | | Mold comp | 4.1E\hat{ }4 | 1.9E\hat{ }4 | 3.9E\hat{ }3 | 3.7E\hat{ }2 | 2.5E\hat{ }4 | N/A |
| 0.70% commercial | 5.82 | Bac comp | 6.5E\hat{ }5 | 8.2E\hat{ }4 | <10 | <10 | 1.6E\hat{ }5 | N/A |
| preservative | | Mold comp | 1.8E\hat{ }4 | 1.6E\hat{ }3 | 2.2E\hat{ }2 | <10 | 1.4E\hat{ }3 | N/A |
| 0.80% Polymer C12 60% | 5.83 | Bac comp | 1.3E\hat{ }6 | 2.7E\hat{ }5 | 1.0E\hat{ }2 | <10 | 1.6E\hat{ }6 | N/A |
| charged in delivery system 3 | | Mold comp | 4.4E\hat{ }4 | 1.9E\hat{ }4 | 1.5E\hat{ }4 | 3.1E\hat{ }3 | 1.9E\hat{ }4 | N/A |
| (Example 4) | | | | | | | | |
| 0.70% commercial | 5.82 | Bac comp | 3.9E\hat{ }5 | 5.3E\hat{ }3 | <10 | <10 | 3.5E\hat{ }3 | <10 |
| preservative + 0.80% | | Mold comp | 2.3E\hat{ }3 | <10 | <10 | <10 | <10 | N/A |
| Polymer C12 60% charged | | | | | | | | |
| in delivery system 3 | | | | | | | | |
| (Example 4) | | | | | | | | |

*Commercial preservative: Benzyl Alcohol (and) Benzoic Acid (and) Glycerin (and) Sorbic Acid.

While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those skilled in the art without departing from the scope and spirit of this invention.

What is claimed is:

1. An antimicrobial polymer composition comprising:
i. about 0.1 wt. % to about 50 wt. % of poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₄ to C₂₀ amines;
ii. about 0.1 wt. % to about 50 wt. % of at least one neutralizing agent for enhancing efficacy of said polymer; and
iii. about 0.1 wt. % to about 99.9 wt. % of a delivery system comprising at least one solvent.

2. The antimicrobial composition according to claim 1, wherein said pseudocationic agent is a tertiary alkyl amines.

3. The antimicrobial composition according to claim 1, wherein said alcohol is C₁ to C₆ alcohol.

4. The antimicrobial composition according to claim 1, wherein said hydrophobic moiety is C₄ to C₁₂ alkyl amines.

5. The antimicrobial composition according to claim 1, wherein said polymer has a molecular weight in the range of from about 2000 to about 80,000 Daltons.

6. The antimicrobial composition according to claim 1, wherein said functionalized poly (isobutylene-co-maleic anhydride) polymer has the structure(s): 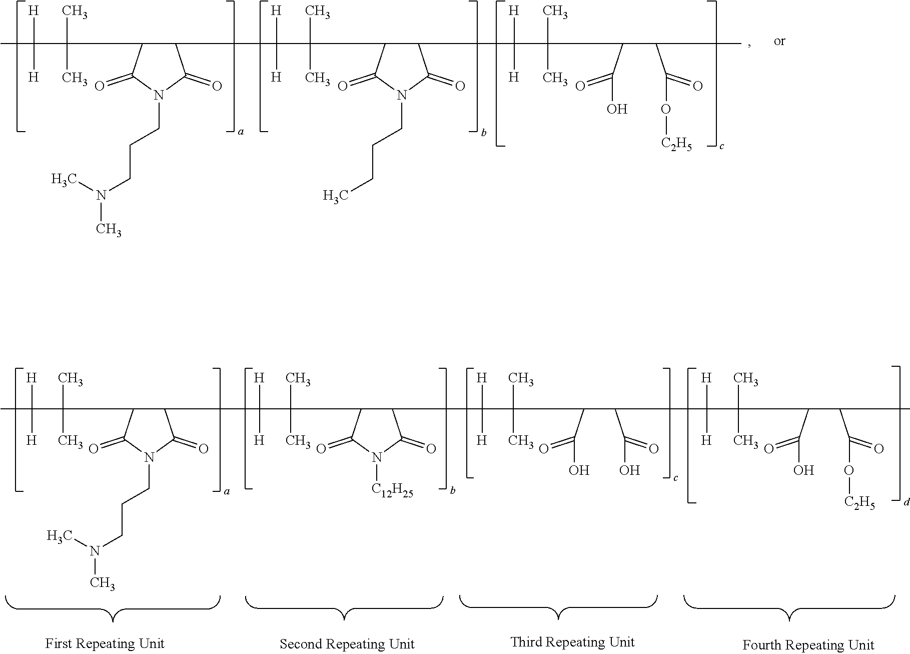
wherein each a, b, c and d has a value from about 0.1 to 100 mole percent with proviso that sum of said a, b, c and d is equal to 100 mole percent, wherein the polymer is alternating, block, or random.

7. The antimicrobial composition according to claim 1, wherein the composition is aqueous, aqueous miscible or non-aqueous in nature.

8. The antimicrobial composition according to claim 1, wherein the composition is non-toxic in nature.

9. The antimicrobial composition according to claim 1, wherein the composition further optionally comprises about 0.1 wt. % to about 25 wt. % of at least one antimicrobial agent.

10. The antimicrobial composition according to claim 9, wherein said antimicrobial agent is selected from the group consisting of alkali metal salts of isothiazolinones, quaternary ammonium salts, triazine derivatives, guanidine compounds, biguanides, poly biguanides, salts of organic acids, fatty amines, diamines, triamines, salts of pyrithione, copper salts, thiocyanates, carbamates, dithiocarbamates, hydantoins, silver based compounds, copper based compounds, formaldehyde releasing compounds, formaldehyde, glutaraldehyde, propionic acid salt, octanoic acid salt, salicylic acid salt, dehydroacetic acid salt, bronopol, phenoxy ethanol, menthol, eugenol, capryl alcohol, coco amine acetate, N-dodecyl-1,3-propanediamine, bis-(3-aminopropyl)dodecylamine, chlorhexidine, alexidine, sodium hydroxymethylglycinate, dimethyloldimethylhydantoin, polyhexamethylene biguanide, diazolidinyl urea, imidazolidinyl urea, polymethoxy bicyclic oxazolidines, benzyl alcohol, hexamidine isethionate, chlorobutanol, dibromopropamidine, tetrakis (hydroxymethyl)phosphonium sulfate (THPS), 2,2-dibromo-3-nitrilopropionamide (DBNPA), tri n-butyl tetradecyl phosphonium chloride (TPC), methylene bis(thiocyanate) (MBT), alkyl dithiocarbamates, alkylene dithiocarbamates, 2-hydroxypyridine-N-oxide, N-nitroso-N-cyclohexyl-hydroxylamine, 8-hydroxy-quinoline, and combinations thereof.

11. The antimicrobial composition according to claim 9, wherein the required effective use levels of antimicrobial agent is reduced to about 2 to 8 times as compared to that of regulatory compliable or conventionally accepted use levels.

12. The antimicrobial composition according to claim 1, wherein said neutralizing is selected from the group consisting of weak organic acids, mineral acids, α-hydroxy acids, β-hydroxy acids, benzoic acid, glycolic acid, dehydroacetic acid, citric acid, anisic acid, salicylic acid, sorbic acid, lauric acid, octanoic acid, hydrochloric acid, pyruvic acid, oxalic acid, ascorbic acid, formic acid, oxalic acid, lactic acid, acetic acid, succinic acid, propionic acid, butyric acid, tartaric acid, malic acid, gluconic acid, fumaric acid, and combinations thereof.

13. The antimicrobial composition according to claim 1, wherein said neutralizing agent is capable of controlling cationic surface charge and counter-ions present in poly (isobutylene-co-maleic anhydride) polymer for its efficacy enhancement, and wherein, the selection of acid and its concentration can be varied to provide complete or partial neutralization in order to enable variable positive charge and to balance the hydrophilic/hydrophobic nature of the polymer in end-use products or applications.

14. The antimicrobial composition according claim 1, wherein said solvent is selected from the group consisting of water, glycols, ethers of glycols, esters of glycols, polyglycols, glycerols, ether or esters of glycerols, diglycerols, triglycerol, tetraglycerol, pentaglycerol, hexaglycerol, cyclic diols, linear or non-cyclic diols, polyglycerols or their derivatives, alkylalkyl glycerins, alkylaryl glycerins, cycloalkyl glycerins, fatty acid ester of C₁ to C₂₄ alcohols, phospholipids, 1,2 alkandiols, 1,3 alkanediols, glycerin chain fatty acid esters, hydroxyorganic acids, aliphatic or aromatic alcohols having carbon chain length of C₁-C₂₀, and combinations thereof.

15. The antimicrobial composition according to claim 1, wherein said composition is capable of inhibiting or killing Staphylococcus aureus, Staphylococcus epidermidis, Streptococcus pneumoniae, Streptococcus pyogenes, Enterococcus faecalis, Haemophilus influenzae, Moraxella species, Salmonella species, Campylobacter species, Pseudomonus aeruginosa, Clostridium botulinum, Clostridium perfringens, Corynebacteria species, Diplococci species, Mycobacteria species, Streptomyces species, Escherichia coli, Salmonella typhimurium, Salmonella enteritidis, Vibrio parahaemolyticus, Bacillus anthracia, Bacillus azotoformans, Bacillus cereus, Bacillus coagulans, Bacillus israelensis, Bacillus larvae, Bacillus mycoides, Bacillus polymyxa, Bacillus pumilis, Bacillus stearothormophillus, Bacillus subtilis, Bacillus thuringiensis, Bacillus validus, Bacillus weihenstephanensis, Bacillus pseudomycoides, Burkholderia cepacia, Burkholderia multivorans, Burkholderia cenocepacia, Burkholderia vietnamiensis, Burkholderia stabilis, Burkholderia ambifaria, Burkholderia dolosa, Burkholderia anthina, Burkholderia pyrrocinia, Candida tropicalis, Candida albicans, Hansenula anomala, Saccharomyces cerevisiae, Torulaspora delbreuckii, Zygosaccharomyces bailii, Zygosaccharomyces rouxii, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, and/or Mucor racemosus.

16. The antimicrobial composition according to claim 1, wherein said composition is employed in the field of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and/or oral care compositions.

17. The antimicrobial composition according to claim 1, wherein said personal care composition includes sun care compositions, after-sun compositions, hair care compositions, conditioning compositions, skin care compositions, oral care compositions, face care compositions, lip care compositions, body care compositions, nail care compositions, anti-aging compositions, deodorant compositions, color cosmetic compositions, color-protection compositions, self-tanning compositions, and foot care compositions.

18. The antimicrobial composition according to claim 1, wherein said composition is formulated as solutions, oils, lotions, creams, ointments, liquids, gels, solids, W/O emulsions, O/W emulsions, milks, suspensions, microemulsions, dispersions, microencapsulated products, sticks, balms, tonics, pastes, mists, reconstitutable products, peels, soaps, aerosols, mousses, waxes, glues, pomades, spritzes, putties, lacquers, serums, perms, powders, pencils, flakes, blush, highlighters, bronzers, concealers, baby wipes, rinse off products, or wet wipes.

19. The antimicrobial composition according to claim 1, wherein said delivery system is capable of providing enhanced efficacy by bringing the polymer to the oil/water interface when incorporated into an aqueous or non-aqueous based end-user applications selected from the group consisting of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and/or oral care compositions.

20. The antimicrobial composition according to claim 1, wherein said polymer is capable of demonstrating multi-functional properties including emulsifying property, moisturizing property, wetting or surface active property, lubricating property, and/or causing less irritation to the substrate.

21. A process for preparing an aqueous antimicrobial composition comprising the steps of:
i. preparing a poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₁ to C₁₂ amines;
ii. neutralizing the polymer obtained in step (i) with about 0.1 wt. % to about 25 wt. % of at least one neutralizing agent;
iii. optionally, incorporating about 0.1 wt. % to about 25 wt. % of at least one antimicrobial agent to step (ii); and
iv. adding about 0.1 wt. % to about 80 wt. % of at least one solvent to step (iii) to obtain desired aqueous antimicrobial composition.

22. A process for preparing an aqueous antimicrobial composition comprising the steps of:
i. preparing a poly (isobutylene-co-maleic anhydride) polymer functionalized with (a) at least one pseudo cationic agent selected from the group consisting of functionalized and unfunctionalized primary, secondary or tertiary amines, (b) at least one compound selected from functionalized and unfunctionalized C₁ to C₁₂ alcohols and (c) at least one hydrophobic moiety selected from functionalized and unfunctionalized C₁ to C₁₂ amines;
ii. neutralizing the polymer obtained in step (i) with about 0.1 wt. % to about 25 wt. % of at least one neutralizing agent;
iii. incorporating about 0.1 wt. % to about 25 wt. % of at least one antimicrobial agent to step (ii); and
iv. adding about 0.1 wt. % to about 80 wt. % of at least one solvent to step (iii) to obtain desired aqueous antimicrobial composition.

23. A method for inhibiting or killing microbial growth comprising incorporating an effective amount of the antimicrobial composition of claim 1 in an aqueous or non-aqueous based end-user application or product selected from the group consisting of food, nutrition, beverages, pharmaceuticals, household and industrial compositions, coatings, paints, biocides, construction, energy, oilfield applications, performance materials, agricultural compositions, veterinary compositions, adhesive compositions, textiles, ink compositions, electronics, membranes, building materials, stucco, concrete, caulks, sealants, joints, leather, wood, pigment dispersions, metal working fluids, drilling mud, clay slurries, seed coatings, pesticide compositions, toiletry, disinfecting, enzyme formulations, latex, in-can preservation, laundry, cosmetics, personal care compositions, hair care compositions, skin care compositions, sun care compositions, and oral care compositions.

24. The method according to claim 23, wherein said end-use products have a pH in the range from about 4 to about 8.

25. The method according to claim 23, wherein the use level antimicrobial composition is in the range of from about 0.01 wt. % to about 5 wt. % of the total composition of the respective end-use products.

26. An antimicrobial polymer composition comprising:
(i) about 0.1 wt. % to about 50 wt. % of at least one multifunctional polymer or comprising at least: (A) at least a first repeating unit selected from the group consisting of: 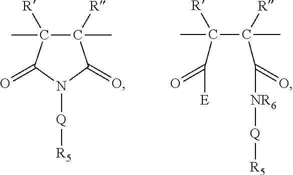
and combinations thereof, and (B) at least a second/third/fourth repeating unit is selected from the group consisting of: 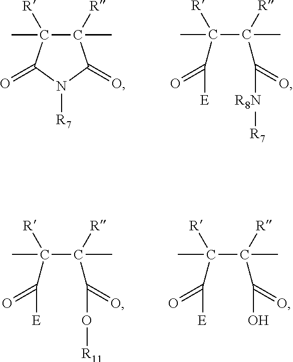
and combinations thereof, wherein
each C— indicates a bond from said unit to another unit along the polymer backbone;
each R′ and R″ is independently selected from the group consisting of: hydrogen, alkyl, cycloalkyl, aryl, and combinations thereof; each R₅ is independently selected from the group consisting of —NR₉R₁₀, functionalized and unfunctionalized nitrogen or phosphorus containing C₅-C₇ cyclic groups, and mixtures thereof; each R₆, R₈, R₉, and R₁₀ is independently selected from the group consisting of hydrogen, functionalized and unfunctionalized alkyl, alkoxy, cycloalkyl, alkenyl, cycloalkenyl, aryl groups, wherein any of the before mentioned groups may be with or without heteroatoms, and mixtures thereof; each R₇ and R₁₁ is independently selected from the group consisting of functionalized and unfunctionalized alkyl, alkoxy, cycloalkyl, alkenyl, cycloalkenyl, and aryl groups, wherein any of the before mentioned groups may be with or without heteroatoms, and mixtures thereof; each Q is independently selected from the group consisting of functionalized or unfunctionalized alkylene, cycloalkylene, and combinations thereof, wherein any of the functionalized or unfunctionalized alkylene groups may be with or without heteroatoms, and mixtures thereof; each E is independently selected from the group consisting of —OM, —OR₇, —NHR₇, —NR₇R₁₁, and mixtures thereof; and each M is independently selected from the group consisting of hydrogen, alkali metal ions, alkaline earth metal ions, ammonium ions, and mixtures thereof, and wherein, the selection of the generic substituent R′ and R″, R₅, R₆, R₇, R₈, R₉, R₁₀, R₁₁, Q, and M provides polymers that exhibit antimicrobial activity as well functionality for formulated compositions;
(ii) about 0.1 wt. % to about 50 wt. % of at least one neutralizing agent for enhancing efficacy of said polymer; and
(iii) about 0.1 wt. % to about 99.9 wt. % of delivery system comprising at least one solvent,
wherein the composition is an aqueous, aqueous miscible or non-aqueous in nature.

27. The antimicrobial composition according to claim 26, wherein the polymer has a molecular weight is in range of from about 2000 to about 80,000 Daltons.

28. An antimicrobial polymer composition comprising:
(i) about 0.1 wt. % to about 50 wt. % of efficacy enhancing poly (isobutylene-co-maleic anhydride) polymer having the structure: 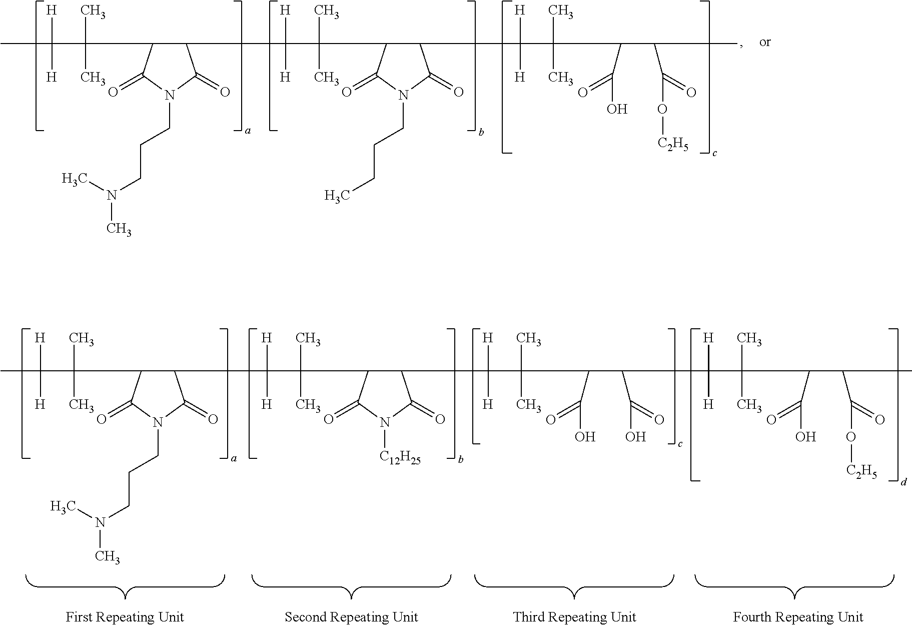
wherein each a, b, c and d has a value from about 0.1 to 100 mole percent with the proviso that the sum of said a, b, c and d is equal to 100 mole percent, wherein the polymer is alternating, block, or random;
(ii) about 0.1 wt. % to about 50 wt. % of at least one neutralizing agent; and
(iii) about 0.1 wt. % to about 99.9 wt. % of a delivery system comprising at least one solvent.

29. The antimicrobial composition according to claim 28, wherein, the ratio of a:b:c:d is 60:5:30:5; 50:10:30:10; 55:10:30:5; or 60:5:25:10.

30. The antimicrobial polymer composition comprising:
(i) about 0.1 wt. % to about 50 wt. % of efficacy enhancing poly (isobutylene-co-maleic anhydride) polymer having a structure of: 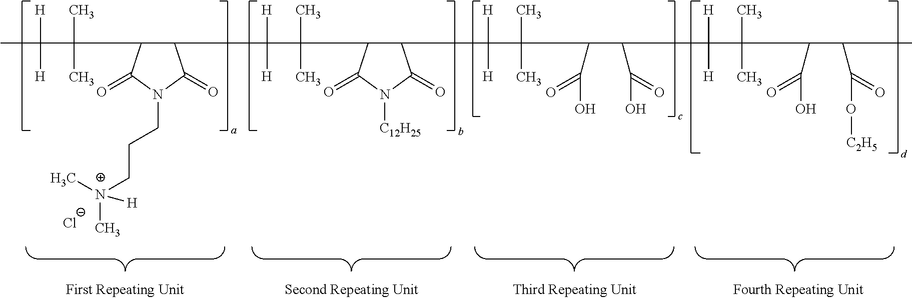
wherein each a, b, c and d has a value from about 0.1 to 100 mole percent with proviso that sum of said a, b, c and d is equal to 100 mole percent, wherein the polymer is alternating, block, or random; and
(ii) about 0.1 wt. % to about 99.9 wt. % of delivery system comprising at least one solvent.

31. The antimicrobial composition according to claim 30, wherein, the ratio of a:b:c:d is 60:5:30:5; 50:10:30:10; 55:10:30:5; or 60:5:25:10.
